(19) United States
(12) Patent Application Publication
(10) Pub. No.: US 2025/0392061 A1
(43) Pub. Date: Dec. 25, 2025

(54) TERMINAL BLOCK WITH MULTIPLE CONTACT POINT CONDUCTION STRUCTURE

(71) Applicants: DINKLE ENTERPRISE CO., LTD., New Taipei City (TW); DINKLE ELECTRIC MACHINERY (CHINA) CO., LTD., Kunshan City (CN); LI YANG ELECTRIC MACHINERY (DONGGUAN) CO., LTD., Dong Guan City (CN)

(72) Inventors: Xiangdong SHENG, Kunshan City (CN); Xu LI, Kunshan City (CN); Xuehou YAO, Kunshan City (CN); Zijian WANG, Kunshan City (CN); Mingshuo HUANG, Kunshan City (CN); Hao CHENG, Kunshan City (CN)

(21) Appl. No.: 18/751,082

(22) Filed: Jun. 21, 2024

(51) Int. Cl. H01R 9/24

(52) U.S. Cl. CPC H01R 9/24

(57) ABSTRACT

A multiple contact point conduction structure of a terminal block is used to make a conductive wire be inserted and includes an electrical conducting terminal. The electrical conducting terminal includes: a terminal body, an electrical conducting contact wall and a wire pressing wall both fastened on the terminal body, The electrical conducting contact wall is formed with an electrical conducting contact surface. The electrical conducting contact surface is formed with a first wire bundling protrusion, the conductive wire is accommodated between the first wire bundling protrusion and the terminal body, the first wire bundling protrusion is formed with a first inclined surface. An outer circumferential surface of the conductive wire tightly contacts the terminal body and the first inclined surface. The wire pressing wall tightly contacts another lateral wall of the conductive wire on the electrical conducting contact surface.

### BACKGROUND OF THE DISCLOSURE

### Technical Field

The present disclosure relates to a connector, especially to a terminal block with a multiple contact point conduction structure.

### Description of Related Art

Please refer from FIG. 1 to FIG. 3, the current structure of a related-art wire connecting terminal block is to form an electrical conducting contact surface 21 of an electrical conducting terminal. A conductive wire 8 having rigid twisted wires is tightly clipped by an elastic force of an elastic sheet S of a suspension structure and the electrical conducting contact surface 21. There is no possibly that an absolute plat and linear structure being formed by the rigid twisted wires of the conductive wire 8 and the electrical conducting contact surface 21 of the electrical conducting terminal being parallelly arranged, thus the maximum amount of contact point is two when the rigid twisted wires of the conductive wires 8 contacting the planar electrical conducting contact surface 21, or only one contact point is provided (a first contact point 81 and a second contact point 8 are formed by the conductive wire 8 and the electrical conducting contact surface 21, as shown in FIG. 1). As such, a flow flowing capability is poor and the wire connecting stability is not sufficient after the wire connecting operation.

### SUMMARY OF THE DISCLOSURE

The present disclosure is to provide a terminal block with a multiple contact point conduction structure, which has advantages of effectively increasing contact points where an electrical conducting terminal contacting a conductive wire, effectively enhancing a current flowing capability of the terminal block is effectively after the wire connection and increasing the performance stability of the terminal block.

Accordingly, the present disclosure provides a terminal block with a multiple contact point conduction structure used to make a conductive wire be inserted, and characterized in including an electrical conducting terminal. The electrical conducting terminal includes: a terminal body; an electrical conducting contact wall fastened on the terminal body, the electrical conducting contact wall is formed with an electrical conducting contact surface used to hold and support the conductive wire, the electrical conducting contact surface contacts one lateral surface of the conductive wire, the electrical conducting contact surface is formed with a first wire bundling protrusion, the conductive wire on the electrical conducting contact surface is accommodated between the first wire bundling protrusion and the terminal body, the first wire bundling protrusion is formed with a first inclined surface towards one lateral wall of the terminal body, an obtuse angle is formed between the first inclined surface and the electrical conducting contact surface, an outer circumferential surface of the conductive wire tightly contact the terminal body and the first inclined surface; a wire pressing wall fastened on the terminal body, the wire pressing wall tightly contacts another lateral wall of the conductive wire on the electrical conducting contact surface, and the another lateral wall faces the aforesaid lateral wall.

According to an improvement of the present disclosure, the electrical conducting contact wall is disposed with a second wire bundling protrusion, a wire feeding direction and a horizonal direction vertical to the wire feeding direction are defined by the terminal body, the second wire bundling protrusion and the first wire bundling protrusion are horizontally arranged on the electrical conducting contact wall and spaced with an interval, the second wire bundling protrusion is formed with a second inclined surface towards one side of the first wire bundling protrusion, an obtuse angle is formed between the second inclined surface and the electrical conducting contact surface, the conductive wire on the electrical conducting contact surface is held and supported on the first inclined surface of the first wire bundling protrusion and the second inclined surface of the second wire bundling protrusion.

According to an improvement of the present disclosure, the contact point where the first inclined surface contacts the conductive wire and the contact point where the second inclined surface contacts the conductive wire are located on a same horizontal cross-sectional plane of the conductive wire, the contact point where the wire pressing wall contacts the conductive wire is closer to an inserting terminal end of the conductive wire being inserted along the wire feeding direction relative to the contact points where the first inclined surface and the second inclined surface contact the conductive wire.

According to an improvement of the present disclosure, a wire feeding side of the first wire bundling protrusion along the wire feeding direction is defined as a third inclined surface, a wire feeding side of the second wire bundling protrusion along the wire feeding direction is defined as a fourth inclined surface, a trumpet-shaped wire feeding structure is formed between the third inclined surface and the fourth inclined surface, the trumpet-shaped wire feeding structure has a gap with a size thereof gradually shrunk along the wire feeding direction.

According to an improvement of the present disclosure, the first wire bundling protrusion and the second wire bundling protrusion are both a V-shaped protruding structure formed by being stretched on the electrical conducting contact wall.

According to an improvement of the present disclosure, the terminal block defines an inserting terminal end of the conductive wire being inserted along the wire feeding direction, the wire pressing wall, the first wire bundling protrusion and the second wire bundling protrusion are located close to the inserting terminal end.

According to an improvement of the present disclosure, the terminal block defines a wire feeding direction, the electrical conducting contact surface further has a sawtooth-shaped convex block and a plurality of convex/concave anti-slip structures arranged along the wire feeding direction and spaced with intervals.

According to an improvement of the present disclosure, the terminal block defines a wire feeding direction, the amount of the first wire bundling protrusion is at least two, the at least two first wire bundling protrusions are parallelly arranged and spaced with an interval on the electrical conducting contact surface along the wire feeding direction.

According to an improvement of the present disclosure, a wire bundling protrusion set is formed by the first wire bundling protrusion and the second wire bundling protrusion, at least three wire bundling protrusion sets are disposed on the electrical conducting contact surface, and the at least three wire bundling protrusion sets are parallelly arranged on the electrical conducting contact surface and spaced with intervals along the wire feeding direction.

According to an improvement of the present disclosure, an elastic sheet is further provided, the elastic sheet includes a supporting part and at least two press connecting parts, the supporting part and the press connecting parts elastically support between the electrical conducting terminal and the conductive wires, the at least two press connecting parts include a first press connecting part and a second press connecting part, the first press connecting part and the second press connecting part press and connect the lateral surface of the conductive wire at locations corresponding to any two of the adjacent wire bundling protrusion sets.

According to an improvement of the present disclosure, the wire bundling protrusion set further includes a third wire bundling protrusion disposed on the electrical conducting contact surface, the third wire bundling protrusion is disposed between the first wire bundling protrusion and the second wire bundling protrusion, the first wire bundling protrusion, the second wire bundling protrusion and the third wire bundling protrusion. are parallelly arranged on the electrical conducting contact wall and spaced with intervals in a horizontal direction, the third wire bundling protrusion is formed with a first corresponding inclined surface towards one side of the first wire bundling protrusion and formed with a second corresponding inclined surface towards one side of the second wire bundling protrusion, an obtuse angle is formed between the first corresponding inclined surface and the electrical conducting contact surface, an obtuse angle is formed between the second corresponding inclined surface and the electrical conducting contact surface, one of the two conductive wires on the electrical conducting contact surface is held and supported on the first inclined surface of the first wire bundling protrusion and the first corresponding inclined surface of the third wire bundling protrusion, the other conductive wire on the electrical conducting contact surface is held and supported on the second inclined surface of the second wire bundling protrusion and the second corresponding inclined surface of the third wire bundling protrusion.

According to an improvement of the present disclosure, the first press connecting part has two press connecting arms, the second press connecting part has two press connecting arms, the two press connecting arms of the first press connecting part and the two press connecting arms of the second press connecting part respectively press and connect the two conductive wires held and supported on the electrical conducting contact surface.

According to an improvement of the present disclosure, the elastic sheet further includes an elastic bending part, the elastic bending part is connected between the supporting part and the at least two press connecting parts, the supporting part is connected to a portion of the elastic bending part, and the at least two press connecting parts are connected to another portion of the elastic bending part.

In comparison with related art, the present disclosure has advantageous features as follows. With the wire pressing wall being formed on the electrical conducting terminal, the wire pressing wall tightly contacts the upper surface of the conductive wire on electrical conducting contact surface. With the first wire bundling protrusion and the second wire bundling protrusion being disposed on the electrical conducting contact surface, the first inclined surface of the first wire bundling protrusion and the second inclined surface of the second wire bundling protrusion hold and support the lateral surface at a distal segment of the conductive wire along the wire feeding direction, meanwhile the wire pressing wall presses the upper surface at the distal segment of the conductive wire, thus contact points where the conductive wire contacts the electrical conducting terminal are effectively increased, the current flowing capability of the wire connecting terminal block is effectively enhanced after the wire connection, the performance stability of the terminal block is increased, thus the wire connection of the conductive wire is more stable.

### BRIEF DESCRIPTION OF THE DRAWINGS

FIG. 1 is a schematic view showing the wire connecting principle of the wire connecting terminal block;

FIG. 2 is a perspective view showing the related-art terminal block;

FIG. 3 is a perspective view showing the related-art electrical conducting terminal;

FIG. 4 is a first perspective view showing the terminal block and the first structure of the electrical conducting terminal thereof according to the present disclosure;

FIG. 5 is a second perspective view showing the terminal block and the first structure of the electrical conducting terminal thereof according to the present disclosure;

FIG. 6 is a perspective view showing the first structure of the electrical conducting terminal in the terminal block according to the present disclosure;

FIG. 7 is a perspective view showing the second structure of the electrical conducting terminal in the terminal block according to the present disclosure;

FIG. 8 is a perspective view showing the second structure of the electrical conducting terminal in the terminal block being in the contacting status with the conductive wire according to the present disclosure;

FIG. 9 is a front view showing the second structure of the electrical conducting terminal in the terminal block being in the contacting status with the conductive wire according to the present disclosure;

FIG. 10 is a perspective view showing the third structure of the electrical conducting terminal in the terminal block according to the present disclosure;

FIG. 11 is a front view showing the third structure of the electrical conducting terminal in the terminal block according to the present disclosure;

FIG. 12 is a perspective view showing the fourth structure of the electrical conducting terminal in the terminal block according to the present disclosure;

FIG. 13 is a front view showing the fourth structure of the electrical conducting terminal in the terminal block according to the present disclosure;

FIG. 14 is a perspective view showing the fourth structure of the electrical conducting terminal in the terminal block being in the contacting status with the conductive wire according to the present disclosure;

FIG. 15 is a front view showing the fourth structure of the electrical conducting terminal of the fourth structure in the terminal block being in the contacting status with the conductive wire according to the present disclosure;

FIG. 16 is a perspective exploded view showing the fifth structure of the electrical conducting terminal and the elastic sheet in the terminal block and the conductive wires according to the present disclosure;

FIG. 17 is a perspective view showing the fifth structure of the electrical conducting terminal and the elastic sheet in the terminal block being in the contacting status with the conductive wires according to the present disclosure; and

FIG. 18 is a cross-sectional view showing the fifth structure of the electrical conducting terminal and the elastic sheet in the terminal block being in the contacting status with the conductive wires according to the present disclosure.

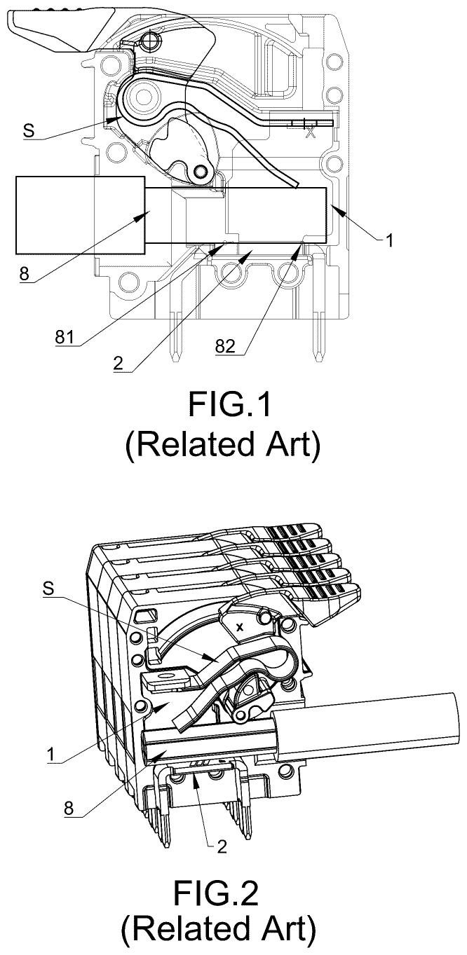

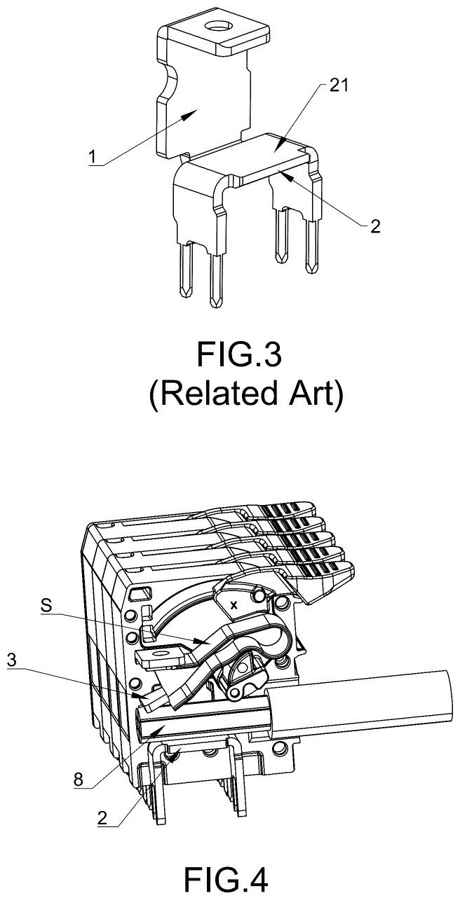

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

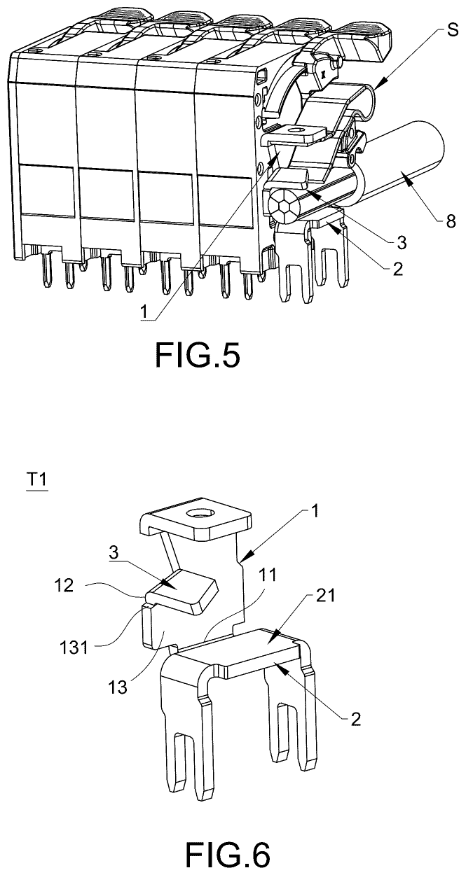

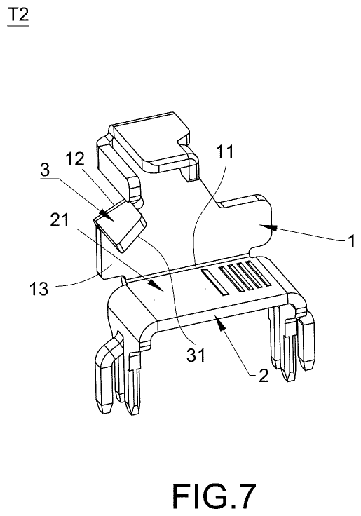

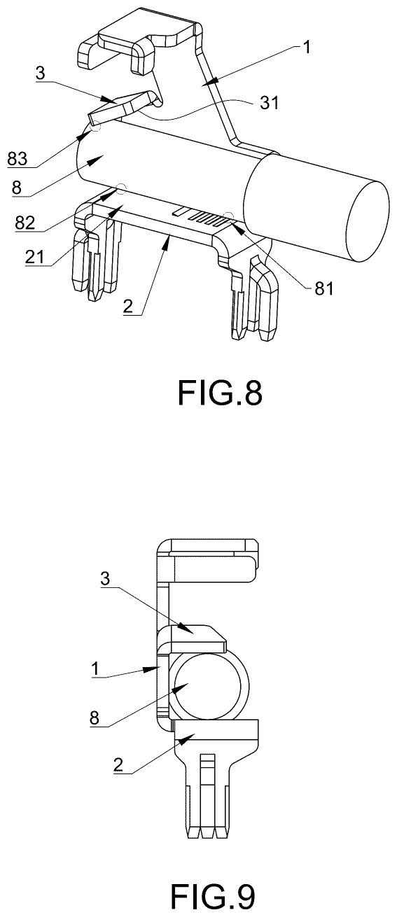

Please refer from FIG. 4 to FIG. 9, the present disclosure provides a terminal block with a multiple contact point conduction structure, used to be electrically connected to a conductive wire 8. Multiple contact point electrical conducting terminals (hereinafter defined as an electric conductive terminals) T1, T2 of the multiple contact point conduction structure includes a terminal body 1 and an electrical conducting contact wall 2. The electrical conducting contact wall 2 is fastened on the terminal body 1. The electrical conducting contact wall 2 is formed with an electrical conducting contact surface 21 used to hold and support the conductive wire 8. A wire feeding direction and a horizonal direction (not shown in figures) vertical to the wire feeding direction are defined by the terminal body 1. One side of the terminal body 1 where the conductive wire 8 contacts the electrical conducting contact surface 21 is defined as a bottom side. The terminal body 1 is disposed with a wire pressing wall 3. The wire pressing wall 3 tightly contacts an upper surface of the conductive wire 8. When the conductive wire 8 is inserted in a wire connecting terminal block (hereinafter defined as a terminal block) via a wire feeding port of the terminal block, the conductive wire 8 is slid to be inserted in the terminal block along the electrical conducting contact surface 21 of the electrical conducting contact wall 2. After the conductive wire 8 is inserted with a specified depth, the conductive wire 8 passes through a gap between the wire pressing wall 3 and the electrical conducting contact surface 21, the wire pressing wall 3 tightly contact the upper surface of the conductive wire 8. As such, the conductive wire 8 is tightly clipped on the electrical conducting contact surface 21 via an elastic sheet S disposed in the terminal block, the amount of contact point where the conductive wire 8 contacts the electrical conducting terminals T1, T2 is at least three, which are a first contact point 81 defined at a location where the elastic sheet S directly faces the clipped conductive wire 8, a second contact point 82 defined at a location where the electrical conducting contact surface 21 and the wire pressing wall 3 directly face the clipped conductive wire 8 and a third contact point 83 defined at a location where the wire pressing wall 3 contacts the conductive wire 8, as shown in FIG. 8. As such, the amount of contact point where the conductive wire 8 contacts the electrical conducting terminals T1, T2 is effectively increased, a signal transferring stability of the wire connecting terminal block is ensured, and a current flowing capability of the terminal block is effectively enhanced, thus an objective of a large current transmission is achieved.

The wire pressing wall 3 is formed with an inclined wire pressing surface 31. An acute angle is formed between inclined wire pressing surface 31 and the electrical conducting contact surface 21, a trumpet-shaped wire passing channel having a wire inlet gap greater than a wire outlet gap is formed between the inclined wire pressing surface 31 and the electrical conducting contact surface 21. The wire outlet gap of the trumpet-shaped wire passing channel is smaller or equal to a diameter of the conductive wire 8, and the wire inlet gap of the trumpet-shaped wire passing channel is greater than the diameter of the conductive wire 8. A trumpet-shaped structure is formed between the inclined wire pressing surface 31 and the electrical conducting contact surface 21 by the wire pressing surface 3 being formed with the inclined wire pressing surface 31, thus an objective of an inserting direction guide being provided to the conductive wire 8 is achieved, thus the conductive wire 8 is smoothly inserted in a gap between the inclined wire pressing surface 31 and the electrical conducting contact surface 21, and smoothly passes through a location where the wire pressing surface 3 directly faces the electrical conducting contact wall 2, and the inclined wire pressing surface 31 and the electrical conducting contact surface 21 tightly contact the conductive wire 8. The wire pressing wall 3 may also be designed as a convex arc-shaped surface or a columnar structure, the aforesaid design is served as examples which are easy to be understood by the skilled people in the art, here is not intended to be limiting.

The wire pressing wall 3 and the electrical conducting contact wall 2 are bending sheets disposed on the terminal body 1 and spaced with an interval. Details are provided as follows. A first bending part 11 is formed between the terminal body 1 and the electrical conducting contact wall 2, A second bending part 12 is formed between the terminal body 1 and the wire pressing wall 3. The electrical conducting contact wall 2 is formed by the first bending part 11 being bent relative to the terminal body 1. The wire pressing wall 3 is formed by the second bending part 12 being bent relative to the terminal body 1. The wire pressing wall 3 and the electrical conducting contact wall 2 are formed by being bent and disposed on the terminal body 1, thus the whole structure of the electrical conducting terminals T1, T2 is simple and easy to be produced, and the wire pressing wall 3 may be bent to form a V-shaped elastic sheet to make the wire pressing wall 3 tightly contact the conductive wire 8 or to prevent the wire pressing wall 3 from affecting the insertion of the conductive wire 8.

Please refer from FIG. 6 to FIG. 9, for making the wire pressing wall 3 be surely bent relative to the terminal body 1, the terminal body 1 is extended with a lateral protruding part 13 along the wire feeding direction, the lateral protruding part 13 has an inclined edge 131 inclined towards the electrical conducting contact surface 21. The wire pressing wall 3 is connected to the inclined edge 131 and inclined with the inclined edge 131 to form the aforesaid inclined wire pressing surface 31. As such, the wire pressing wall 3 is inclined relative to the electrical conducting contact wall 2 and spaced with an interval as shown in figures.

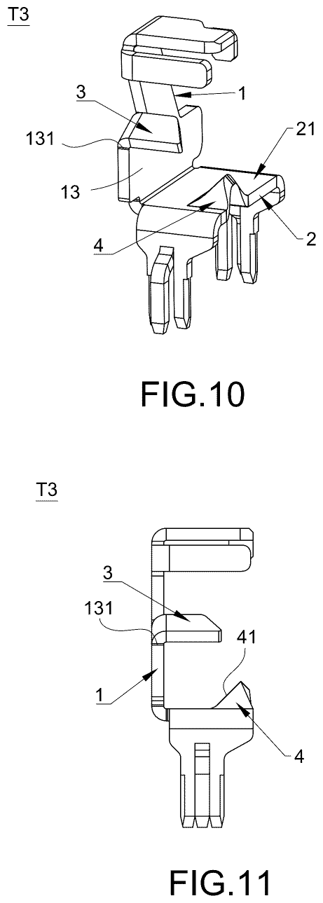

Please refer to FIG. 10 and FIG. 11, the electrical conducting contact surface 21 of an electrical conducting terminal T3 is disposed with a first wire bundling protrusion 4. The conductive wire 8 on the electrical conducting contact surface 21 is accommodated between the first wire bundling protrusion 4 and the terminal body 1. The first wire bundling protrusion 4 is formed with a first inclined surface 41 towards one lateral wall of the terminal body 1. An obtuse angle is formed between the first inclined surface 41 and the electrical conducting contact surface 21. Two locations defined at an outer circumferential surface of the conductive wire 8 tightly contact the terminal body 1 and the first inclined surface 41. With the first wire bundling protrusion 41 being disposed on the electrical conducting contact surface 21, the conductive wire 8 is bundled and restrained along a width direction (or a horizontal direction) of the electrical conducting contact surface 21 via the first inclined surface 41 of the first wire bundling protrusion 4, thus the outer circumferential surface of the conductive wire 8 constantly contact the terminal body 1 and the first inclined surface 41, and two contact points are provided, which are a fourth contact point (not coded) where the conductive wire 8 contacts the terminal body 1 and a fifth contact point 84 where the conductive wire 8 contacts the first inclined surface 41, as shown in FIG. 15. The most desired location where the first wire bundling protrusion 4 being disposed is an edge at one side of the electrical conducting contact surface 21 in the width direction (the horizontal direction) and away from the terminal body 1.

In some embodiments not provided with figures, the amount of the first wire bundling protrusion 4 is at least two, the at least two first wire bundling protrusions 4 are parallelly arranged and spaced with an interval on the electrical conducting contact surface 21 along the wire feeding direction. As such, more contact points are provided.

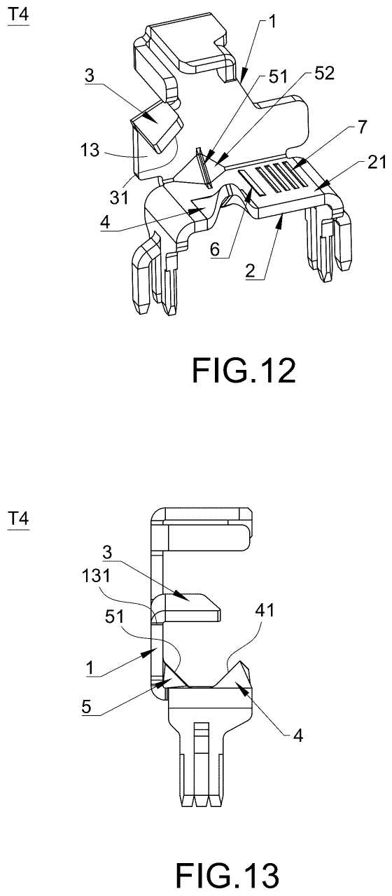

Please refer from FIG. 12 to FIG. 15, the electrical conducting contact wall 2 (or the electrical conducting contact surface 21) of an electrical conducting terminal T4 is further disposed with a second wire bundling protrusion 5. The second wire bundling protrusion 5 and the first wire bundling protrusion 4 are arranged on the electrical conducting contact wall 2 (or the electrical conducting contact surface 21) along a left/right (or a horizontal) direction. The second wire bundling protrusion 5 is formed with a second inclined surface 51 towards one side of the first wire bundling protrusion 4. An obtuse angle is formed between the second inclined surface 51 and the electrical conducting contact surface 21. The conductive wire 8 on the electrical conducting contact surface 21 is held and supported on the first inclined surface 41 of the first wire bundling protrusion 4 and the second inclined surface 51 of the second wire bundling protrusion 5. A V-shaped wire supporting and wire bundling structure is formed by the second inclined surface 51 of the second wire bundling protrusion 5 and the first inclined surface 41 of the first wire bundling protrusion 4, thus the conductive wire 8 constantly contacts the first inclined surface 41 and the second inclined surface 51, and two contact points are provided which are a fifth contact point 84 where the conductive wire 8 contacts the first inclined surface 41 and a sixth contact point 85 where the conductive wire 8 contacts the second inclined surface 51. As such, the conductive wire 8 is smoothly inserted between the first inclined surface 41 and the second inclined surface 51, and the most desired location where the second wire bundling protrusion 5 being disposed is a location where the electrical conducting contact surface 21 engages with the terminal body 1.

Accordingly, with the wire pressing wall 3 being formed on the electrical conducting terminal T4, the wire pressing wall 3 tightly contacts the upper surface of the conductive wire 8. With the first wire bundling protrusion 4 and the second wire bundling protrusion 5 being disposed on the electrical conducting contact surface 21, the first inclined surface 41 of the first wire bundling protrusion 4 and the second inclined surface 51 of the second wire bundling protrusion 5 hold and support a lateral surface at a distal segment of the conductive wire 8 along the wire feeding direction, meanwhile the wire pressing wall 3 presses the upper surface at the distal segment of the conductive wire 8, thus contact points where the conductive wire 8 contacts the electrical conducting terminal T4 are effectively increased, the current flowing capability of the wire connecting terminal block is effectively enhanced after the wire connection, the performance stability of the terminal block is increased, thus the wire connection of the conductive wire 8 is more stable.

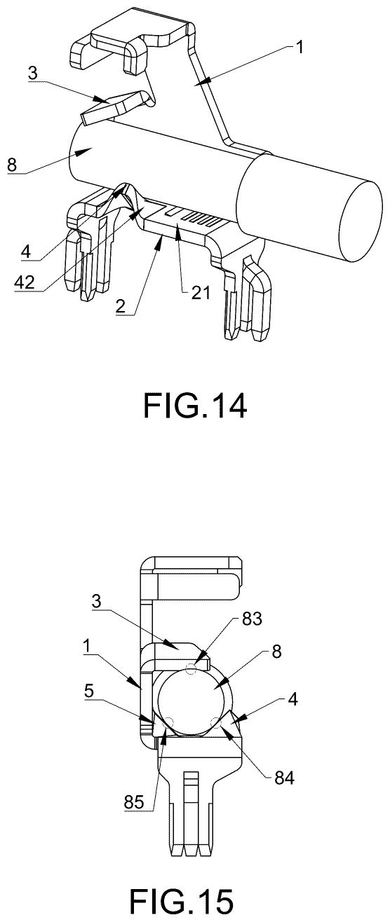

The contact point where the first inclined surface 41 contacts the conductive wire 8 and the contact point where the second inclined surface 51 contacts the conductive wire 8 are located on a same horizontal cross-sectional plane of the conductive wire 8. The contact point where the wire pressing wall 3 contacts the conductive wire 8 is closer to the distal part of the conductive wire 8 along the wire feeding direction relative to the contact points where the first inclined surface 41 and the second inclined surface 51 contact the conductive wire 8, as shown in FIG. 14. The conductive wire 8 is firstly inserted in the V-shaped wire supporting and wire bundling structure between the first inclined surface 41 and the second inclined surface 51 and then forwardly moved a certain distance, the conductive wire 8 is fed between the electrical conducting contact surface 21 and the wire pressing surface 3 and then tightly pressed after being released from the V-shaped wire supporting and wire bundling structure. As such, during the insertion process of the conductive wire 8, no interference is generated and a resisting force is small. The contact points may be designed on the same horizontal cross-sectional plane, here is not intended to be limiting.

A wire feeding side of the first wire bundling protrusion 4 along the wire feeding direction is defined as a third inclined surface 42. A wire feeding side of the second wire bundling protrusion 5 along the wire feeding direction is defined as a fourth inclined surface 52. A trumpet-shaped wire feeding structure with a gap having a size thereof gradually shrunk is formed between the third inclined surface 42 and the fourth inclined surface 52 along the wire feeding direction. With the trumpet-shaped wire feeding structure formed by the third inclined surface 42 and the fourth inclined surface 52, the conductive wire 8 is smoothly fed between the first wire bundling protrusion 4 and the second wire bundling protrusion 5 during the inserting process, and no interference is generated.

The first wire bundling protrusion 4 and the second wire bundling protrusion 5 are both a V-shaped protruding structure formed by being stretched on the electrical conducting contact wall 2. With the first wire bundling protrusion 4 and the second wire bundling protrusion 5 being protruded and stretched on the electrical conducting contact wall 2, the structure is simple and easy to be produced.

The terminal block 1 defines an inserting terminal end of the conductive wire 8 being inserted along the wire feeding direction. The wire pressing wall 3, the first wire bundling protrusion 4 and the second wire bundling protrusion 5 are all arranged on the electrical conducting contact surface 21 and located close to the inserting terminal end of the conductive wire 8 being inserted along the wire feeding direction. As such, a front segment of the conductive wire 8 is rapidly inserted, and the action of the elastic sheet S tightly clipping the conductive wire 8 is not affected.

The electrical conducting contact surface 21 further has a sawtooth-shaped convex block 6 and a plurality of convex/concave anti-slip structures 7 arranged along the wire feeding direction and spaced with intervals A pull-resisting force of the conductive wire 8 is increased via the sawtooth-shaped convex block 6 and the plurality of convex/concave anti-slip structures 7, thus the conductive wire 8 is prevented from being pulled out by an external force.

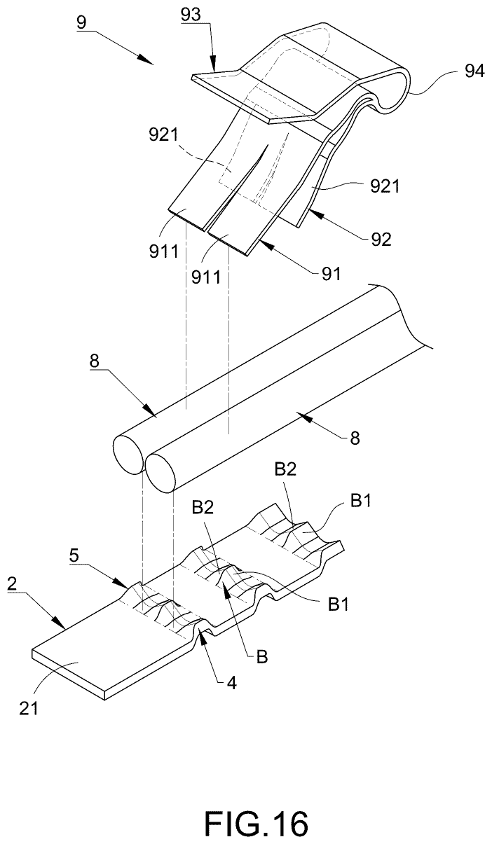

Please refer from FIG. 16 to FIG. 18, the electrical conducting contact wall 2 (or the electrical conducting contact surface 21) is further disposed with a third wire bundling protrusion B. The third wire bundling protrusion B is disposed between the first wire bundling protrusion 4 and the second wire bundling protrusion 5. A wire bundling protrusion set (not coded) is formed by the first wire bundling protrusion 4, the second wire bundling protrusion 5 and the third wire bundling protrusion B. At least two or at least three of the wire bundling protrusion sets are disposed on the electrical conducting contact wall 2 (or the electrical conducting contact surface 21), the amount of the wire bundling protrusion set is three as shown in FIG. 16, and the at least three wire bundling protrusion sets are parallelly arranged on the electrical conducting contact surface 21 and spaced with intervals along the wire feeding direction. Details are provided as follows. The first wire bundling protrusion 4, the second wire bundling protrusion 5 and the third wire bundling protrusion B of each of the wire bundling protrusion sets are horizontally and parallelly arranged on the electrical conducting contact wall 2 (or the electrical conducting contact surface 21) and spaced with intervals. The third wire bundling protrusion B is formed with a first corresponding inclined surface B1 towards one side of the first wire bundling protrusion 4. The third wire bundling protrusion B is formed with a second corresponding inclined surface B2 towards one side of the second wire bundling protrusion 5. An obtuse angle is formed between the first corresponding inclined surface B1 and the electrical conducting contact surface 21. An obtuse angle is formed between the second corresponding inclined surface B2 and the electrical conducting contact surface 21.

Accordingly, when the amount of the conductive wire 8 is two, one of the conductive wires 8 on the electrical conducting contact surface 21 is held and supported on the first inclined surface 41 of the first wire bundling protrusion 4 and the first corresponding inclined surface B1 of the third wire bundling protrusion B. The other conductive wire 8 on the electrical conducting contact surface 21 is held and supported on the second inclined surface 51 of the second wire bundling protrusion 5 and the second corresponding inclined surface B2 of the third wire bundling protrusion B. As such, even if there are two conductive wires 8 held and supported on the electrical conducting contact surface 21, the same amount of contact point is provided as the situation of only one conductive wire 8 being held and supported.

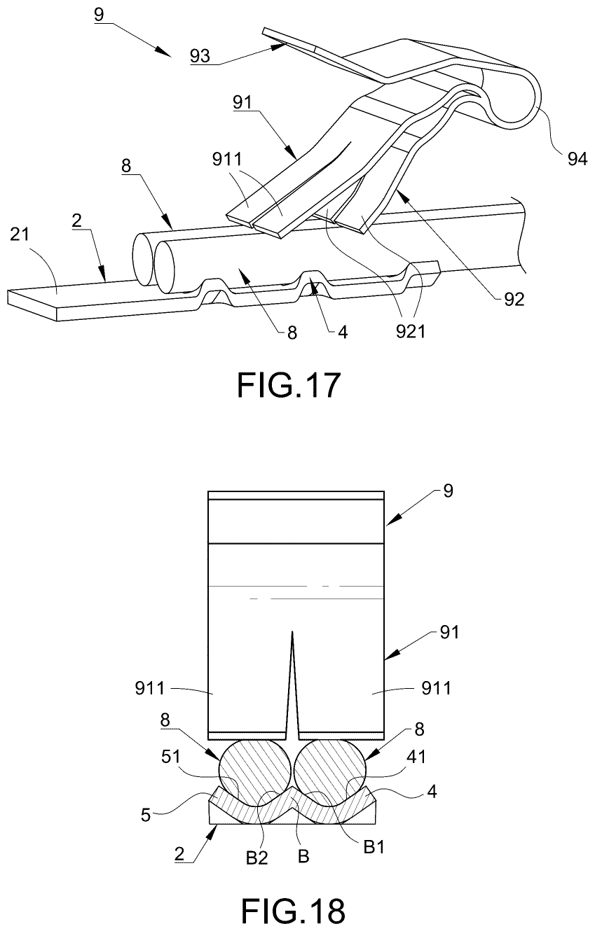

For matching the electrical conducting contact wall 2 having the plurality of the wire bundling protrusion sets, the elastic sheet 9 is correspondingly configured. The elastic sheet 9 includes a supporting part 93, an elastic bending part 94 and at least two press connecting parts. The elastic bending part 94 is connected between the supporting part 93 and the at least two press connecting parts. The supporting part 93 is connected to a portion of the elastic bending part 94. The at least two press connecting parts are connected to another portion of the elastic bending part 94. The at least two press connecting parts includes a first press connecting part 91 and a second press connecting part 92. The supporting part 93 and all the press connecting parts respectively and elastically support between the electrical conducting terminal and all of the conductive wires 8. The first press connecting part 91 and the second press connecting part 92 press and connect at any desired location of the conductive wire 8. In some embodiments, the first press connecting part 91 and the second press connecting part 92 respectively press and connect the conductive wire 8 at locations corresponding to any two of the adjacent wire bundling protrusion sets, and both press on the upper surface of the conductive wire 8, as shown in FIG. 17. As such, the aforesaid amount of contact point between the conductive wire 8 and the electrical conducting contact surface 21 is ensured.

Details are provided as follows. The first press connecting part 91 has two press connecting arms 911. The second press connecting part 92 has two press connecting arms 921. The two press connecting arms 911 of the first press connecting part 91 respectively press and connect the two conductive wires 8 held and supported on the electrical conducting contact surface 21. The two press connecting arms 921 of the second press connecting part 92 respectively press and connect the two conductive wires 8 held and supported on the electrical conducting contact surface 21. Thus, the elastic sheet 9 is ensured to press and connect each of the conductive wires 8.

In some embodiments not provided with figures, when there is only one conductive wire 8 and there are at least two V-shaped wire supporting and wire bundling structures, the first press connecting part 91 and the second press connecting part 92 of the elastic sheet 9 correspondingly have one press connecting arm 911 and one press connecting arm 921, thus the press connecting arm 911 of the first press connecting part 91 and the press connecting arm 921 of the second press connecting part 92 respectively press and connect the conductive wire 8 at locations corresponding to any two of the adjacent V-shaped wire supporting and wire bundling structures.

While this disclosure has been described by means of specific embodiments, numerous modifications and variations could be made thereto by those skilled in the art without departing from the scope and spirit of this disclosure set forth in the claims.

What is claimed is:

1. A terminal block with a multiple contact point conduction structure, for a conductive wire to be inserted, and the terminal block comprising:
an electrical conducting terminal, comprising:
a terminal body;
an electrical conducting contact wall, fastened on the terminal body,
wherein the electrical conducting contact wall comprises an electrical conducting contact surface for supporting the conductive wire, the electrical conducting contact surface contacts one lateral surface of the conductive wire, the electrical conducting contact surface comprises a first wire bundling protrusion, the conductive wire supported on the electrical conducting contact surface is accommodated between the first wire bundling protrusion and the terminal body, the first wire bundling protrusion comprises a first inclined surface disposed towards one lateral wall of the terminal body, an obtuse angle is defined between the first inclined surface and the electrical conducting contact surface, an outer circumferential surface of the conductive wire contact the terminal body and the first inclined surface; and
a wire pressing wall, fastened on the terminal body, wherein the wire pressing wall contacts another lateral surface of the conductive wire on the electrical conducting contact surface, and the another lateral surface faces the one lateral surface.

2. The terminal block according to claim 1, wherein the electrical conducting contact surface comprises a second wire bundling protrusion, a wire feeding direction and a horizonal direction vertical to the wire feeding direction are defined on the terminal body, the second wire bundling protrusion and the first wire bundling protrusion are spacedly arranged on the electrical conducting contact wall along the horizontal direction, the second wire bundling protrusion comprises a second inclined surface disposed towards one side of the first wire bundling protrusion, obtuse angle is defined between the second inclined surface and the electrical conducting contact surface, and the conductive wire on the electrical conducting contact surface is supported on the first inclined surface of the first wire bundling protrusion and the second inclined surface of the second wire bundling protrusion.

3. The terminal block according to claim 2, wherein a contact point where the first inclined surface contacts the conductive wire and a contact point where the second inclined surface contacts the conductive wire are located on a same horizontal cross-sectional plane of the conductive wire, a contact point where the wire pressing wall contacts the conductive wire is closer to an inserting terminal end of the conductive wire being inserted along the wire feeding direction than the contact points where the first inclined surface and the second inclined surface contact the conductive wire.

4. The terminal block according to claim 2, wherein a wire feeding side of the first wire bundling protrusion along the wire feeding direction is defined as a third inclined surface, a wire feeding side of the second wire bundling protrusion along the wire feeding direction is defined as a fourth inclined surface, a trumpet-shaped wire feeding structure is disposed between the third inclined surface and the fourth inclined surface, and the trumpet-shaped wire feeding structure comprises a gap with a size gradually shrunk along the wire feeding direction.

5. The terminal block according to claim 2, wherein the first wire bundling protrusion and the second wire bundling protrusion are both a V-shaped protruding structure formed by being stretched on the electrical conducting contact wall.

6. The terminal block according to claim 3, wherein the first wire bundling protrusion and the second wire bundling protrusion are both a V-shaped protruding structure formed by being stretched on the electrical conducting contact wall.

7. The terminal block according to claim 4, wherein the first wire bundling protrusion and the second wire bundling protrusion are both a V-shaped protruding structure formed by being stretched on the electrical conducting contact wall.

8. The terminal block according to claim 2, wherein an inserting terminal end is defined on the conductive wire being inserted along the wire feeding direction, the wire pressing wall, the first wire bundling protrusion and the second wire bundling protrusion are located close to the inserting terminal end.

9. The terminal block according to claim 3, wherein an inserting terminal end is defined on the conductive wire being inserted along the wire feeding direction, the wire pressing wall, the first wire bundling protrusion and the second wire bundling protrusion are located close to the inserting terminal end.

10. The terminal block according to claim 1, wherein a wire feeding direction is defined on the terminal block, the electrical conducting contact surface further comprises a sawtooth-shaped convex block and a plurality of convex/concave anti-slip structures spacedly arranged along the wire feeding direction.

11. The terminal block according to claim 1, wherein a wire feeding direction is defined on the terminal block, an amount of the first wire bundling protrusion is at least two, at least two first wire bundling protrusions are parallelly and spacedly arranged on the electrical conducting contact surface along the wire feeding direction.

12. The terminal block according to claim 2, wherein a wire bundling protrusion set is structured with the first wire bundling protrusion and the second wire bundling protrusion, at least three wire bundling protrusion sets are disposed on the electrical conducting contact surface, and the at least three wire bundling protrusion sets are parallelly and spacedly arranged on the electrical conducting contact surface along the wire feeding direction.

13. The terminal block according to claim 12, further comprising: an elastic sheet, wherein the elastic sheet comprises a supporting part and at least two press connecting parts, the supporting part and the press connecting parts elastically support between the electrical conducting terminal and the conductive wire, the at least two press connecting parts comprise a first press connecting part and a second press connecting part, the first press connecting part and the second press connecting part press the one lateral surface of the conductive wire at locations corresponding to any two of the adjacent wire bundling protrusion sets.

14. The terminal block according to claim 13, wherein the wire bundling protrusion set further comprises a third wire bundling protrusion disposed on the electrical conducting contact surface, the third wire bundling protrusion is disposed between the first wire bundling protrusion and the second wire bundling protrusion, the first wire bundling protrusion, the second wire bundling protrusion and the third wire bundling protrusion are parallelly and spacedly arranged on the electrical conducting contact wall in a horizontal direction, the third wire bundling protrusion comprises a first corresponding inclined surface towards one side of the first wire bundling protrusion and a second corresponding inclined surface towards one side of the second wire bundling protrusion, obtuse angle is defined between the first corresponding inclined surface and the electrical conducting contact surface, obtuse angle is defined between the second corresponding inclined surface and the electrical conducting contact surface, one of two conductive wires on the electrical conducting contact surface is supported on the first inclined surface of the first wire bundling protrusion and the first corresponding inclined surface of the third wire bundling protrusion, another conductive wire on the electrical conducting contact surface is supported on the second inclined surface of the second wire bundling protrusion and the second corresponding inclined surface of the third wire bundling protrusion.

15. The terminal block according to claim 13, wherein the first press connecting part comprises two press connecting arms, the second press connecting part comprises two press connecting arms, the two press connecting arms of the first press connecting part and the two press connecting arms of the second press connecting part press the two conductive wires supported on the electrical conducting contact surface.

16. The terminal block according to claim 13, wherein the elastic sheet further comprises an elastic bending part, the elastic bending part is connected between the supporting part and the at least two press connecting parts, the supporting part is connected to one portion of the elastic bending part, and the at least two press connecting parts are connected to another portion of the elastic bending part.
